(19) United States
(12) Patent Application Publication
(10) Pub. No.: US 2003/0206161 A1
(43) Pub. Date: Nov. 6, 2003

(54) Tablet integrated type monitor filter

(76) Inventors: Fa-Chung Liu, Hsin-Chu City (TW); Chia-Jui Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/135,458

(22) Filed: May 1, 2002

(51) Int. Cl. G09G 5/00

(52) U.S. Cl. 345/173

(57) ABSTRACT

An electromagnetic tablet integrated type monitor filter is disclosed in this invention. By employing the electromagnetic tablet integrated type monitor filter according to this present invention, the user can directly perform the input of hand-writing, hand-writing drawing, and the like functions. Therefore, the tablet integrated type monitor filter can not only save working space, but also provide a way for hand-writing input, that is more similar to the writing habits of the users.

### BACKGROUND OF THE INVENTION

1. Field of the Invention

This present invention relates to a monitor filter, and more particularly to a tablet integrated type monitor filter.

2. Description of the Prior Art

In the prior art, as shown in FIG. 1, a PC tablet mostly comprises an upper plastic shell 10, a tablet 20 comprising a set of X/Y antenna layers, and a lower shielding plate 30, wherein the shielding plate 30 is plated with zinc or consists of silicon steel. The PC tablet is usually utilized to perform hand-writing input or hand-writing drawing functions. Most PC tablets work by electromagnetic wave induction. In the above-mentioned PC tablet, after calculating the coordinate and pressure value of the electromagnetic pen 40, coordinate, button, pressure, and the like parameters are transmitted from the tablet to a computer. Subsequently, computer software will show the moving mode of the electromagnetic pen 40 on a monitor.

However, the PC tablet in the prior art occupies a part of working space during using the PC tablet. Therefore, from the viewpoint of integration, the PC tablet in the prior art is not economical. Moreover, while utilizing the PC tablet in the prior art, the user always performs the hand-writing input function on a horizontal table, and watches the output from a vertical display. For most users, especially those performing the hand-writing drawing function, it is very inconvenient to perform the hand-writing input function and watch the output on a different plane.

Accordingly, under the trend of higher integration, it is an important object to provide a more convenient hand-writing apparatus.

### SUMMARY OF THE INVENTION

In accordance with the present invention, a tablet integrated type monitor filter is provided for isolating portions of light from a monitor and performing the hand-writing input function.

It is another object of this invention to provide a tablet integrated type monitor filter, so the user can directly perform the hand-writing input function on the above-noted monitor filter.

Still another object of this invention is to provide a tablet integrated type monitor filter, so the user can directly perform the hand-writing drawing function on the above-noted monitor filter.

Still another object of this invention is to provide a tablet integrated type monitor filter, which occupies less working space than the PC tablet in the prior art.

In accordance with the above-mentioned objects, this present invention provides a tablet integrated type monitor filter. The tablet integrated type monitor filter at least comprises a transparent substrate, a set of antenna layers, wherein the antenna layer is printed on the transparent substrate with a transparent conductive material, a controlling circuit, and a frame. According to this invention, the tablet is integrated with a monitor filter, thus the tablet can occupy less working space than the tablet in the prior art. Moreover, according to this invention, the tablet is integrated with a monitor filter, the user can directly perform the hand-writing input or hand-writing drawing function on the monitor filter. Therefore, this present invention provides the user a convenient way to perform the hand-writing input or hand-writing drawing function.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a diagram showing an electromagnetic tablet in prior art;

FIG. 2A is a diagram showing a tablet integrated type monitor filter according to this present invention;

FIG. 2B is a diagram showing the transparent region of the tablet integrated type monitor filter according to this invention;

FIG. 2C is another diagram showing the transparent region of the tablet integrated type monitor filter according to this invention;

FIG. 3A shows a lateral view of the tablet integrated type monitor filter according to this invention; and

FIG. 3B is a schematic diagram of the fastening means of the tablet integrated type monitor filter according to this invention.

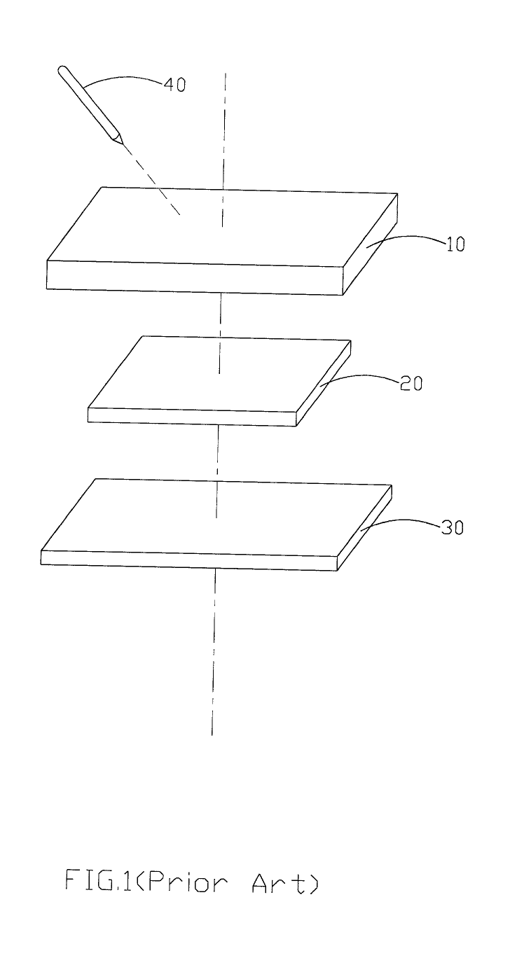

### DESCRIPTION OF THE PREFERRED EMBODIMENTS

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

Hereinafter, the manufacture of the members of this invention, such as baking, etching, printing, coating, and so on, is not the point of this invention, therefore the process of manufacture will not be illustrated in this application.

In addition, the components of the semiconductor devices are not shown to scale. Some dimensions are exaggerated to the related components to provide a more clear description and an improved comprehension of the present invention.

One preferred embodiment of this invention is about a tablet integrated type monitor filter. The monitor filter according to this embodiment comprises a transparent substrate, a set of antenna layers, a tablet controlling circuit, a transparent layer, and a frame. The transparent substrate is made of a transparent glass, or like transparent material. The antenna layers consist a transparent/translucent material, such as indium tin oxide (ITO). A conventional process, such as a circuit printing process forms the antenna layer.

The above-mentioned monitor filter is coupled with an electromagnetic pen through electromagnetic induction. In other words, the moving trace of the electromagnetic pen is induced in the antenna layer of the monitor filter through electromagnetic induction, wherein the moving trace comprises the moving trace of the electromagnetic pen in the horizontal direction and in the vertical direction. The antenna layer is electrically coupled with a tablet controlling circuit. The moving trace of the electromagnetic pen is suffered to the process of wave filtering, rectification, analogy to digital conversion, frequency counting, and the like in the tablet controlling circuit. After the above-mentioned process, the parameters, such as coordinate, button, pressure, and so on, will be transmitted from the tablet controlling circuit to a computer. Finally, the computer software will present the moving trace of the electromagnetic pen as the reaction of a pointer on a monitor.

In this manner, the monitor filter in this embodiment further comprises a transparent protective layer formed on the antenna layer for keeping the antenna layer from the damage from the user's side while utilizing the monitor filter. The monitor filter further comprises a frame. The frame combines the above-mentioned members, such as the transparent substrate, the antenna layer, and the transparent protective layer, and provides a means to fasten the monitor filter to a monitor.

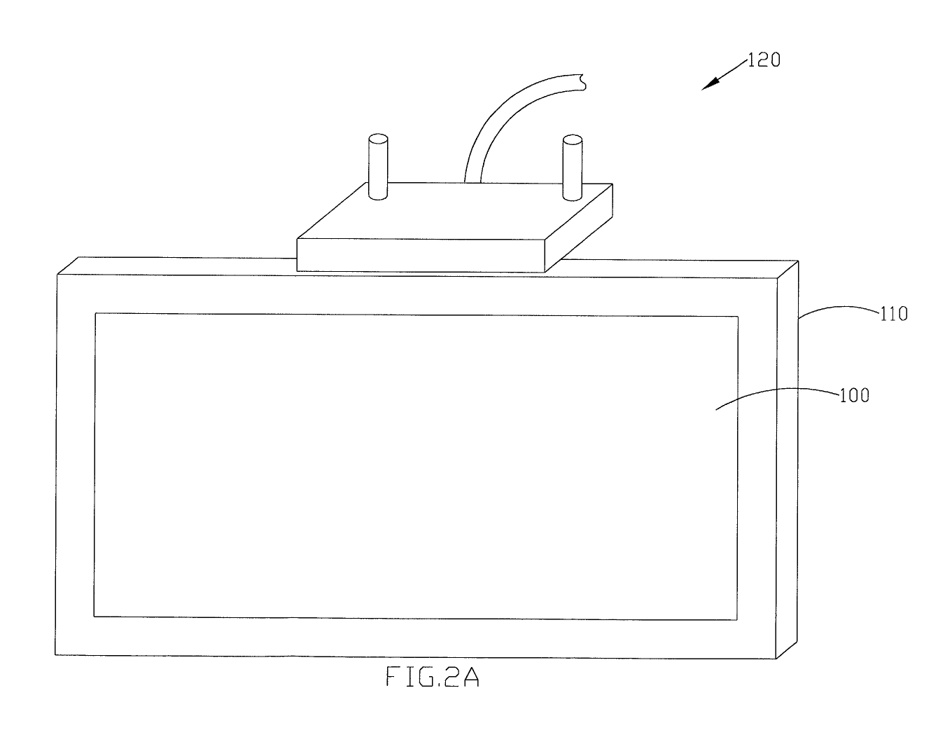

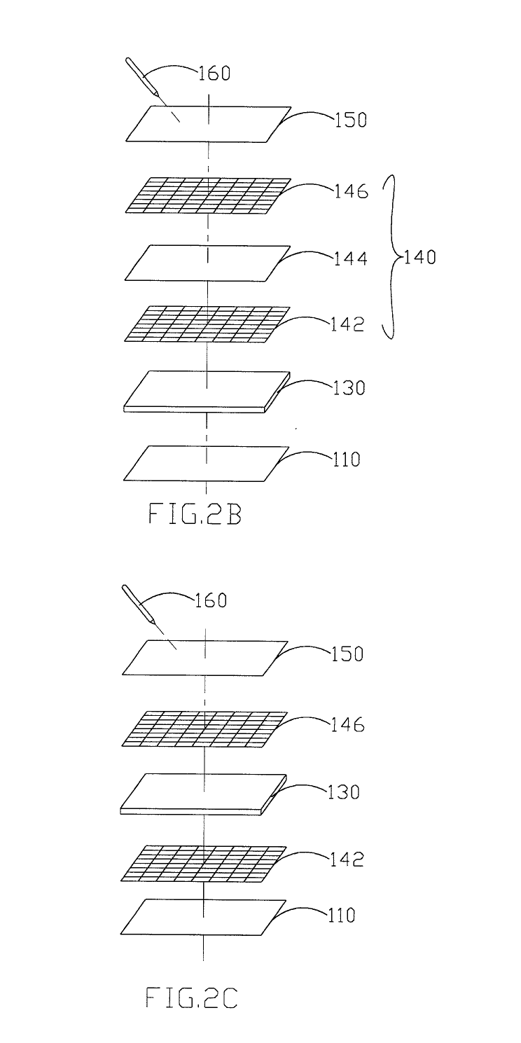

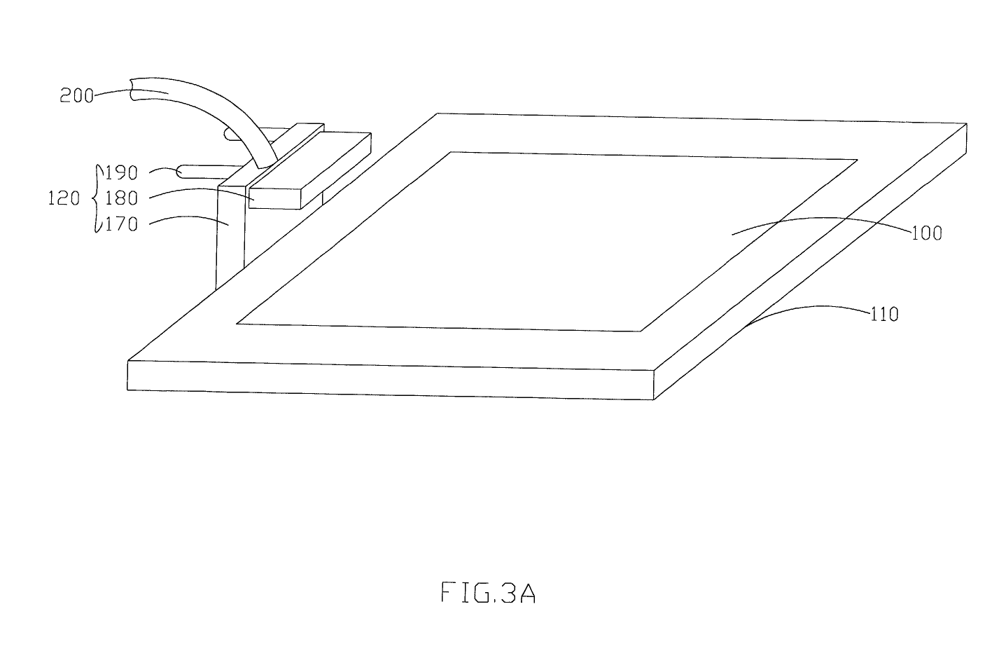

Another embodiment of this present invention is about a tablet integrated type monitor filter. FIG. 2A is an elevation of the tablet integrated type monitor filter according to this embodiment. As shown in FIG. 2A, the above-mentioned monitor filter comprises a transparent region 100, a frame 110, and a fastening means 120. Referred to FIG.2B, the transparent region 100 comprises a transparent substrate 130, an antenna layer 140, and a transparent protective layer 150. The transparent substrate 100 is a transparent material such as glass. The antenna layer 140 is formed on the outside surface (on the user's side) of the transparent substrate 130. The antenna layer 140 comprises a first transparent conductive layer 142, an insulator layer 144, and a secondary conductive layer 146. The first transparent conductive layer 142 is formed on the outside surface (on the user's side) of the transparent substrate 130. The insulator layer 144 is formed on the first transparent conductive layer 142 to prevent the unwanted electric coupling between the first transparent conductive layer 142 and the secondary transparent conductive layer 146. The secondary transparent conductive layer 146 is formed on the insulator layer 144, as shown in FIG. 2B.

The above-mentioned antenna layer 140 can also be disposed in the transparent region 100 as shown in FIG. 2C. For the convenience of circuit printing, the first transparent conductive layer 146 is formed on the surface at the monitor's side of the transparent substrate 130, and the secondary transparent conductive layer 146 is formed on the surface on the user's side of the transparent substrate 130.

The first transparent conductive layer 142 may be the X-axis antenna layer (or the Y-axis antenna layer) of the tablet integrated monitor filter according to this present invention, and the secondary transparent conductive layer 146 may be the Y-axis antenna layer (or the X-axis antenna layer) of the tablet integrated monitor filter according to this present invention. The first transparent conductive layer 142 and the secondary transparent conductive layer 146 are consisted of a transparent/or translucent conductive material as ITO. Besides, a conventional process, such as a circuit printing process, forms the first transparent conductive layer 142 and the secondary transparent conductive layer 146.

The above-mentioned X/Y-axis antenna layers, including the first transparent conductive layer 142 and the secondary transparent conductive layer 146, can induce the moving trace of a electromagnetic pen 160, such as the moving trace in the horizontal direction and in the vertical direction, through an electromagnetic wave. The tablet integrated type monitor filter in this embodiment further comprises a tablet controlling circuit electrically coupled with the above-mentioned X/Y-axis antenna layer, not shown in FIG. 2A. The above-noted tablet controlling circuit may be disposed in the fastening means 120. The electromagnetic variation from the electromagnetic pen 160 can be transmitted from the above-mentioned X/Y-axis antenna layer to the tablet controlling circuit. After the tablet controlling circuit process' the wave filtering, rectification, analogy to digital conversion, frequency counting, and the like, the electromagnetic pen 160 parameters, such as coordinate, pressure, and so on, are received by the tablet controlling circuit. The above-mentioned parameters of the electromagnetic pen 160 will be transmitted from the tablet controlling circuit to a computer by universal serial bus (USB) or the like. Subsequently, the computer software will present the responses of the electromagnetic pen 160 moving trace as the cursor on a monitor.

Moreover, in this embodiment, the tablet integrated type monitor filter further comprises a transparent protective layer 150, which is disposed on the secondary transparent conductive layer 146. The transparent conductive layer 150 can keep the secondary transparent conductive layer 146 on the user's side of the transparent substrate 130 from the damage of the electromagnetic pen 160 or the like. Preferably, the transparent conductive layer 150 can reduce the damage of light from a monitor, i.e. the transparent conductive layer 150 can decrease the transparency of the monitor filter. The transparent protective layer 150 is consisted of glass, plastics, acrylic fiber, or the like transparent materials. For example, the above-mentioned transparent protective layer may be a coated glass (FG-SA1T9). The thickness of the coated glass is about 2.0 mm±0.3 mm. The transparency (T%) of the coated glass is ≧90%±5%, and the reflection ratio (R%) is ≦2%. Therefore, the above-mentioned coated glass can efficiently reduce monitor light damage and the loss of transparency. Protect the user's side of secondary transparent conductive layer 146 of the transparent substrate 130, from damage of the electromagnetic pen 160 or the like. Preferably, the above-noted transparent protective layer will not influence the function of the monitor.

Finally, a frame 110 is employed to combine the transparent protective layer and the transparent substrate with the transparent antenna layer. An opening is left in the frame 110 for a signal line (as USB), not shown in the figure, connecting to the tablet controlling circuit. The tablet controlling circuit may be disposed in the fastening means of the monitor filter in this embodiment, and will not cover the transparent region 100. The frame 110 may be made of plastics.

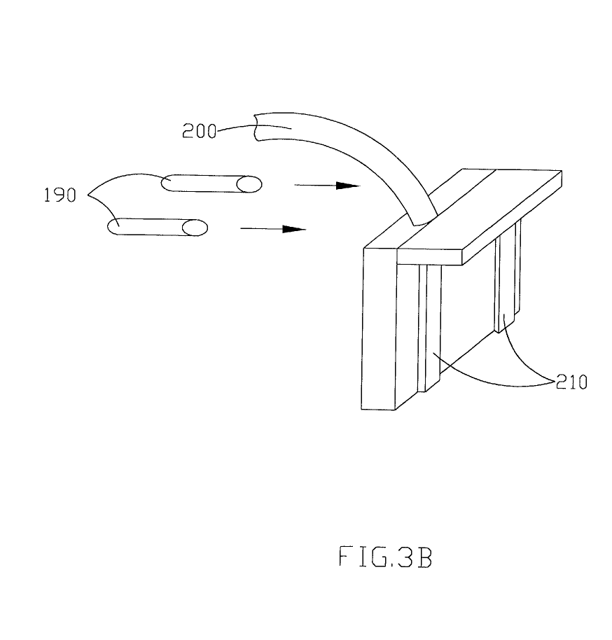

In this embodiment, the tablet integrated type monitor filter further comprises a fastening means 120 for attaching the above-mentioned monitor filter to a monitor. FIG. 3 is a lateral view of the monitor filter in this embodiment. From FIG. 3, the fastening means 120 comprises a connecting arm 170, and a clamp 180. The fastening means 120 is linked to the frame 110 through the connecting arm 170. A tablet controlling circuit, not shown in the figure, is disposed in the connecting arm 170, wherein the above-mentioned tablet controlling circuit is electrically coupled with the X/Y-axis antenna layer of the monitor filter in this embodiment. The tablet controlling circuit can transmit signals, as the calculated parameters in the tablet controlling circuit, to a computer through a signal line 200, such as USB.

FIG. 3B is a diagram of the fastening means 120 according to this embodiment. Two slideways 210 are disposed in the connecting arm 170, and, in fact, the distance between the clamp 180 and the frame 110 can be adjusted thereby. The fastening means 120 further comprises a set of screws 190. While the clamp 180 is adjusted to a suitable position, the screws are employed to fix the clamp 180, and the monitor filter according to this embodiment is disposed on a monitor thereof.

According to the above-mentioned embodiments, this present invention discloses an electromagnetic tablet integrated type monitor filter. The aspect of this invention is employing an electromagnetic tablet integrated type monitor filter to combine an electromagnetic tablet and a monitor to follow the high integration trend. Besides, by utilizing the tablet integrated type monitor filter, the user can directly perform the hand-writing input and hand-writing drawing functions on a monitor. Hence, the electromagnetic tablet integrated type monitor filter according to this present invention can not only save working space, but also raises the utility of a monitor. On the other hand, because the hand-writing input function is directly performed on a monitor filter, the electromagnetic tablet integrated type monitor filter is closer to the writing habits of the user. Therefore, the tablet integrated type monitor filter according to this present invention is a more practical tool than the tablet in the prior art.

Although specific embodiments have been illustrated and described, it will be obvious to those skilled in the art that various modifications may be made without departing from what is intended to be limited solely by the appended claims.

What is claimed is:

1. A structure of tablet integrated type monitor filter, comprising:
a transparent substrate;
an antenna layer disposed on said transparent substrate, wherein said antenna layer can detect moving trace of an electromagnetic pen by electromagnetic wave;
a transparent protective layer disposed on said antenna layer, wherein said transparent protective layer can isolate part of light from a monitor;
a tablet controlling circuit, wherein said tablet controlling circuit is electronically coupled with said antenna layer; and
a frame, wherein said frame is utilized for combine said transparent substrate, said antenna layer, and said transparent protective layer.

2. The structure according to claim 1, wherein said transparent substrate is glass.

3. The structure according to claim 1, wherein said antenna layer comprises a first transparent conductive layer and a secondary transparent conductive layer.

4. The structure according to claim 3, wherein said first transparent conductive layer and said secondary transparent conductive layer are formed on opposite surfaces of said transparent substrate.

5. The structure according to claim 1, wherein said antenna layer comprises:
a first transparent conductive layer disposed on one surface of said transparent substrate;
a transparent insulator layer disposed on said first transparent conductive layer; and
a secondary transparent conductive layer disposed on said transparent insulator layer.

6. The structure according to claim 1, wherein the tablet integrated type monitor filter further comprises a fastening means, wherein said fastening means is linked to said frame.

7. A structure of tablet integrated type monitor filter, comprising:
a transparent substrate;
a first transparent conductive layer disposed on one surface of said transparent substrate, wherein said first transparent conductive layer can detect moving trace of an electromagnetic pen by electromagnetic wave;
an insulator layer disposed on said first transparent conductive layer;
a secondary transparent conductive layer disposed on said insulator layer, wherein said secondary transparent conductive layer can detect moving trace of the electromagnetic pen by electromagnetic wave;
a transparent protective layer disposed on said secondary transparent conductive layer;
a tablet controlling circuit, wherein said tablet controlling circuit is electronically coupled with said first transparent conductive layer and said secondary transparent conductive layer;
a frame, wherein said frame is utilized for combining said transparent substrate and said transparent protective layer; and
a fastening means, wherein said fastening means is linked to said frame.

8. The structure according to claim 7, wherein said transparent substrate is glass.

9. The structure according to claim 7, wherein said first transparent conductive layer and said secondary transparent conductive layer are consisted of a transparent conductive material.

10. The structure according to claim 7, wherein said first transparent conductive layer and said secondary transparent conductive layer are consisted of ITO.

11. The structure according to claim 7, wherein said transparent protective layer is glass.

12. The structure according to claim 7, wherein said fastening means comprises:
a connecting arm linked to said frame;
a clamp disposed on said connecting arm, wherein said clamp is adjustable by a set of slideway in said connecting arm; and
a set of screw disposed on said connecting arm, wherein said screw is utilized for fix said clamp through said slideway.

13. A structure of tablet integrated type monitor filter, comprising:
a transparent substrate;
a first transparent conductive layer disposed on one surface of said transparent substrate, wherein said first transparent conductive layer can detect moving trace of an electromagnetic pen by electromagnetic wave;
a secondary transparent conductive layer disposed on another surface of said transparent substrate, wherein said secondary transparent conductive layer can detect moving trace of the electromagnetic pen by electromagnetic wave;
a transparent protective layer disposed on said secondary transparent conductive layer;
a tablet controlling circuit, wherein said tablet controlling circuit is electronically coupled with said first transparent conductive layer and said secondary transparent conductive layer;
a frame, wherein said frame is utilized for combining said transparent substrate and said transparent protective layer; and
a fastening means, wherein said fastening means is linked to said frame.

14. The structure according to claim 13, wherein said transparent substrate is glass.

15. The structure according to claim 13, wherein said first transparent conductive layer and said secondary transparent conductive layer are consisted of a transparent conductive material.

16. The structure according to claim 13, wherein said first transparent conductive layer and said secondary transparent conductive layer are consisted of a translucent conductive material.

17. The structure according to claim 13, wherein said first transparent conductive layer and said secondary transparent conductive layer are made of ITO.

18. The structure according to claim 13, wherein said transparent protective layer is glass.

19. The structure according to claim 13, wherein said fastening means comprises:
a connecting arm linked to said frame;
a clamp disposed on said connecting arm, wherein said clamp is adjustable by a set of slideway in said connecting arm; and
a set of screw disposed on said connecting arm, wherein said screw is utilized for fix said clamp through said slideway.

20. The structure according to claim 19, wherein said tablet controlling circuit is disposed in said connecting arm.
